(19) United States
(12) Patent Application Publication
(10) Pub. No.: US 2004/0089425 A1
(43) Pub. Date: May 13, 2004

(54) DUAL CONFORMAL FILM SEALING APPARATUS

(75) Inventors: Andrew Z. Glovatsky, Plymouth, MI (US); Prasanna Ramsagar, Southfield, MI (US); Jin Zhou, Troy, MI (US)

Correspondence Address: VISTEON 29074, BRINKS HOFER GILSON & LIONE, P.O. BOX 10395, CHICAGO, IL, 60611, US

(73) Assignee: Visteon Global Technologies, Inc.

(21) Appl. No.: 10/292,565

(22) Filed: Nov. 12, 2002

(51) Int. Cl. B32B 31/00

(52) U.S. Cl. 156/580

(57) ABSTRACT

A sealing tool for sealing upper and lower surfaces of a flatwire by applying a conformal film to the surfaces. The sealing tool includes a tape holder and a tape roller. The tape roller is sized to fit within the tape holder and includes rollers positioned to apply the conformal film to the flatwire. The sealing tool may also include a base sized to receive the tape holder for positioning the sealing tool relative to the flatwire to be repaired.

### FIELD OF THE INVENTION

The present invention relates to applying a protective film to wiring or electronics, and more particularly relates to an apparatus for applying a conformal film to a flatwire segment and related electronics for environmental protection.

### BACKGROUND OF THE INVENTION

Typical wiring, including flatwire or other flexible cable, defines one or more conductive elements which are sheathed in a protective layer of conformal film or coating to seal the conductive elements from the environment. Typically, the conformal film is a dielectric material which is sprayed onto the element to protect it from moisture, fungus, dust, corrosion, abrasion and other mechanical or environmental stresses. Common conformal coatings include silicone, acrylic, urethane, epoxy and Parylene.

When flatwire or a related electronic device is either upgraded or repaired, exposed conductors typically remain which must be sealed from the environment with a conformal coating or film. Unfortunately, the typical process of spraying a conformal coating and allowing the material to cure is costly and time consuming. Further, this form of conformal coating does not provide the breadth of protection afforded by other conformal coatings such as films or tapes. A sheet of conformal film can provide a larger area of protection in much less time than sprayed on conformal coatings. However, in the field, the application of such a conformal film is very difficult in terms of properly aligning the film, as well as smoothly applying the film to the flatwire or related device. For example, surface contours on the flatwire make smooth and uniform application of the conformal coating difficult. Uneven application of the film will result in air pockets, and passageways exposing the electrical device or wire to the undesired elements of the environment.

Accordingly, there exists a need to provide an application tool and method which quickly and easily applies a conformal film to the exposed conductors, while providing a complete seal that eliminates any exposure of the electrical device or wire to the environment.

### BRIEF SUMMARY OF THE INVENTION

The present invention provides a sealing tool for sealing upper and lower surfaces of a flatwire by applying a conformal film to the surfaces. The conformal film is carried by a unique tape for allowing the conformal film to be utilized with the sealing tool. Further, opposing upper and lower surfaces of the flatwire may be sealed simultaneously.

Generally, the sealing tool comprises a tape holder and a tape roller. The tape holder has an upper jaw and a lower jaw defining slots for receiving first and second tapes having the conformal film. The tape roller is sized to fit within the tape holder and includes upper and lower rollers positioned to apply the conformal coating of the tapes to the opposing surfaces of the flatwire. Preferably, the upper and lower jaw are hingedly connected to allow the repaired or upgraded segment of flatwire to be placed between the two tapes. The tape holder also preferably includes a guide slot for receiving and guiding the tape roller.

Additional equipment in the sealing tool may also include a base sized to receive the tape holder for positioning the sealing tool relative to the flatwire to be repaired. Further, a unique tape is employed for use with the tool. Preferably, the tape includes a backer layer attached to the conformal film layer. The backer layer is sized to fit within the slots of the upper and lower jaws, and is retained by the tape holder upon application of the conformal film to the flatwire. To accomplish the same, the backer layer is larger than the conformal film layer to define a gripping portion extending beyond the conformal film layer. Accordingly, conformal films of any size and shape may be utilized within the confines of the backer layer. Finally, the upper and lower rollers make take many different configurations for smoothly applying the conformal coating layer to the flatwire.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a perspective view of a tape holder forming a part of the sealing tool constructed in accordance with the teachings of the present invention;

FIG. 2 is a perspective view of the tape roller forming a part of the sealing tool constructed in accordance with the teachings of the present invention;

FIG. 3 is a perspective view of an alternate embodiment of the tape roller depicted in FIG. 2;

FIG. 4 is a perspective view of an alternate embodiment of a tape roller depicted in FIG. 2;

FIG. 4a is a cross-section view of the tape roller generally taken along line 4a-4a in FIG. 4;

FIG. 5 is a perspective view of a base fixture forming a portion of the sealing tool constructed in accordance with the teachings of the present invention;

FIG. 6 is a top view of a conformal film tape for use with the sealing tool of the present invention;

FIG. 7 is a cross sectional view of the conformal film tape depicted in FIG. 6 and generally taken along line 7-7;

FIGS. 8-11 depicts the process of utilizing the sealing tool to apply the conformal film to a flatwire; and

FIG. 12 depicts the resulting configuration of a repaired flatwire using the tool depicted in FIGS. 1-7 and the process depicted in FIGS. 8-11.

### DETAILED DESCRIPTION OF THE INVENTION

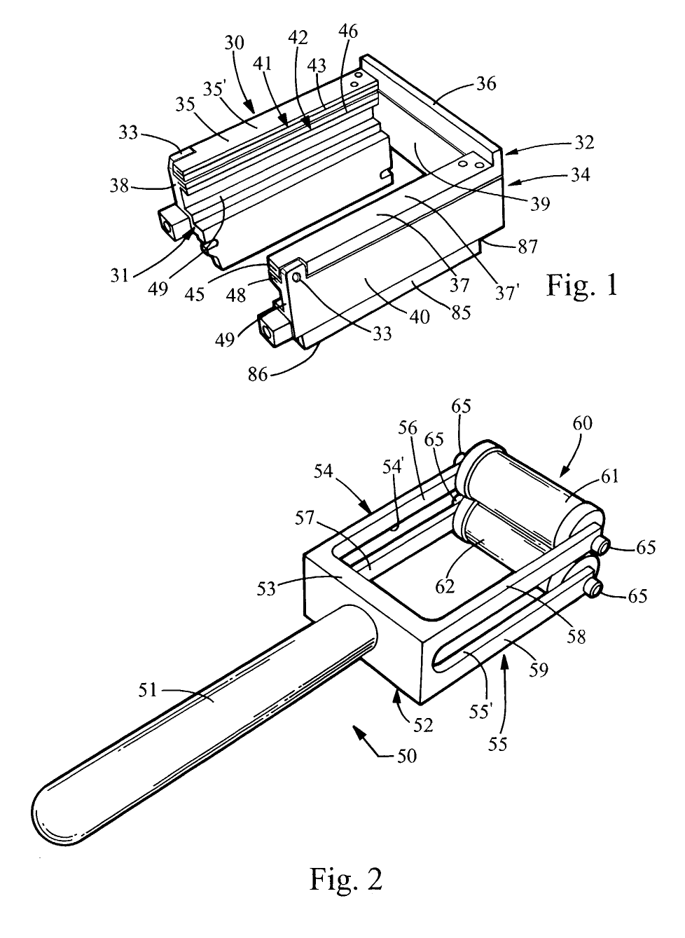

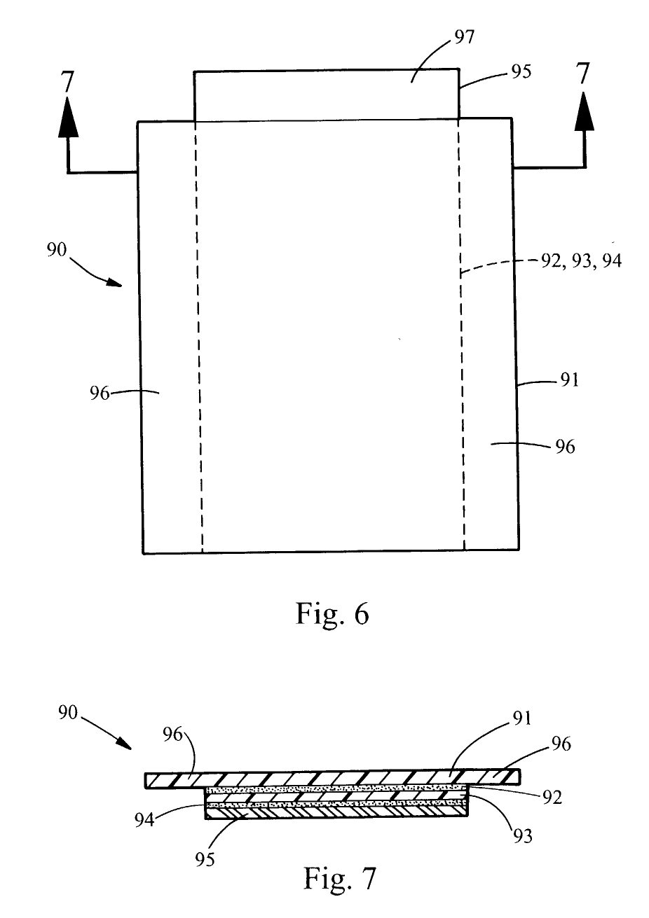

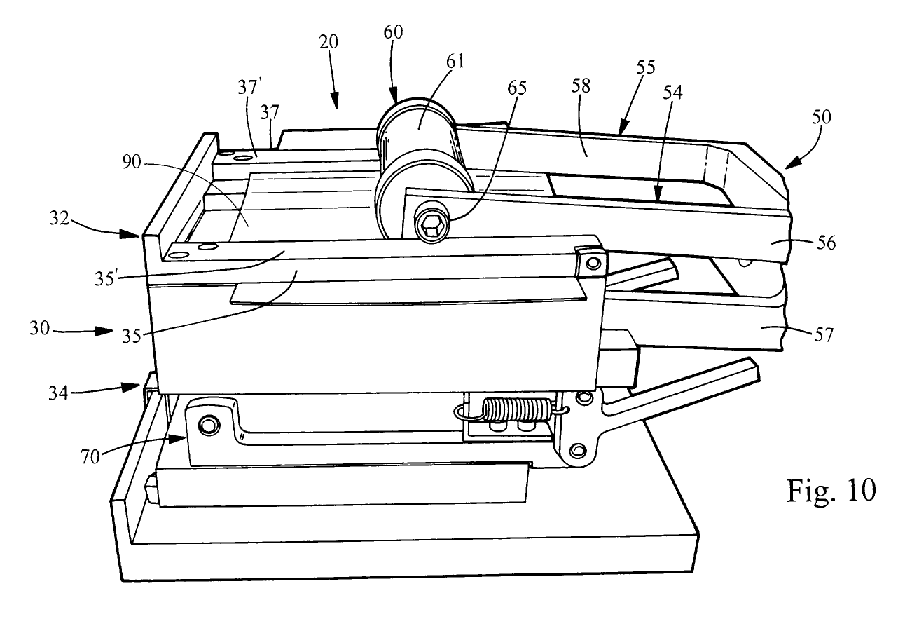

Turning now to the figures, the sealing apparatus or tool 20 of the present invention is constructed of a number of components, namely a tape holder 30 (FIG. 1), a tape roller 50 (FIG. 2), and a base fixture 70 (FIG. 5). Additionally, a unique tape 90 (FIGS. 6 and 7) is employed in conjunction with the sealing tool 20 (shown together in FIG. 10). The sealing tool 20 is especially adapted for applying a conformal film to the upper and lower surfaces of a flatwire section that has been repaired or upgraded. As used herein, the term flatwire refers to wiring such as ribbon cable and flat flexible cable, as well as any electronics or hardware incorporated thereon such as flatwire buses or flatwire circuit boards.

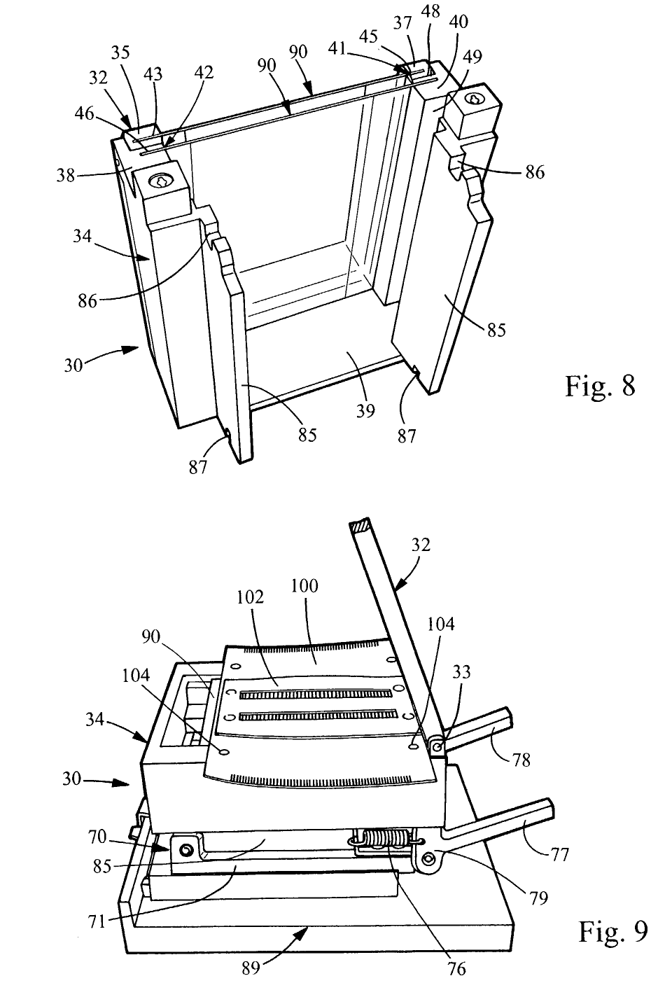

First, the components of the sealing tool 20 will be discussed with reference to FIGS. 1-7, and then, the process of applying the conformal film to flatwire utilizing the sealing tool 20 will be described with reference to FIGS. 8-12.

As shown in FIG. 1, the tape holder 30 is provided for holding and locating the tape 90 (FIGS. 6-7) for application of a conformal film to the flatwire with the roller 50 (FIG. 2). The tape holder 30 generally includes an upper jaw 32 and a lower jaw 34, which are hingedly connected at pivot points 33 such that the jaws 32, 34 may rotate relative to one another. More specifically, the upper jaw 32 includes a left wall 35, a rear wall 36 and a right wall 37. Similarly, the lower jaw 34 includes a left wall 38, a rear wall 39 and a right wall 40. It can be seen that the left and right walls 33, 38, 37, 40 are connected by the rear walls 36, 39 forming generally a U-shape with the pivot points 33 being located toward the open end of that shape.

The tape holder 30 defines an upper slot 41 and a lower slot 42 for receiving and retaining the tape 90. In the illustrated embodiment, the upper slot 41 is defined by aligned channels 43 and 45 formed in the left wall 35 and right wall 37, respectively. Likewise, the lower slot 42 is defined by aligned channels 46, 48 formed in left wall 38 and right wall 40, respectively. The slots 41 and 42 are sized and positioned to locate the tapes 90 in a predetermined position for application of the conformal film to the flatwire.

The tape holder 30 also defines a guide slot 31 for guiding the tape roller 50 when positioned within the tape holder 30. The guide slot 31 generally comprises opposing channels 49 formed in the left wall 38 and right wall 40 of the lower jaw 34. In conjunction with the guide slot 31, the upper surfaces 35′, 37′ of the left and right walls 35, 37 are used to guide the tape roller 50.

It can be seen that the tape holder 30, as defined by its upper and lower jaws 32, 34, opens forwardly allowing insertion and removal of the tape roller 50, as well as two conformal tapes 90. The rear walls 36, 39 restrict the movement of the tape roller 50 relative to the tape holder 30, although the guide slot 31 can also be structured to accomplish the same.

As shown in FIG. 2, the tape roller 50 generally includes a handle 51 connected to a roller support frame 52. The frame 52 generally includes a cross bar 53 attached to the handle 51. Left and right arms 54, 55 extend from opposing ends of the connector 53. The left arm 54 generally includes an upper finger 56 and a lower finger 57; and similarly the right arm 55 includes an upper finger 58 and a lower finger 59. Stated another way, the left arm 54 includes a slot 54′ defining upper and lower fingers 56, 57. Likewise, the right arm 55 includes a slot 55′ defining upper and lower fingers 58, 59.

Attached to the arms 54, 55 are a pair of rollers 60. More specifically, an upper roller 61 and a lower roller 62 are vertically spaced a small distance as will be described in more detail herein. The upper roller 61 is attached between the upper fingers 56, 58, while the lower roller 62 is attached between the lower fingers 57, 59. A tab or projection 65 is positioned adjacent each end of the rollers 61, 62 and projects outwardly from the fingers 56, 57, 58, 59 of the arms 54, 55. Preferably, the projections 65 are aligned with the central axes of the rollers 61, 62. The projections 65 of the lower fingers 57, 59 are sized and positioned to correspond with the guide slot 31, and more specifically the opposing channels 49 formed in the lower jaw 34 of the tape holder 30. The projections 65 of the upper fingers 56, 57 are guided by the upper surfaces 35′, 37′ of the upper jaw 32 of the tape holder 30.

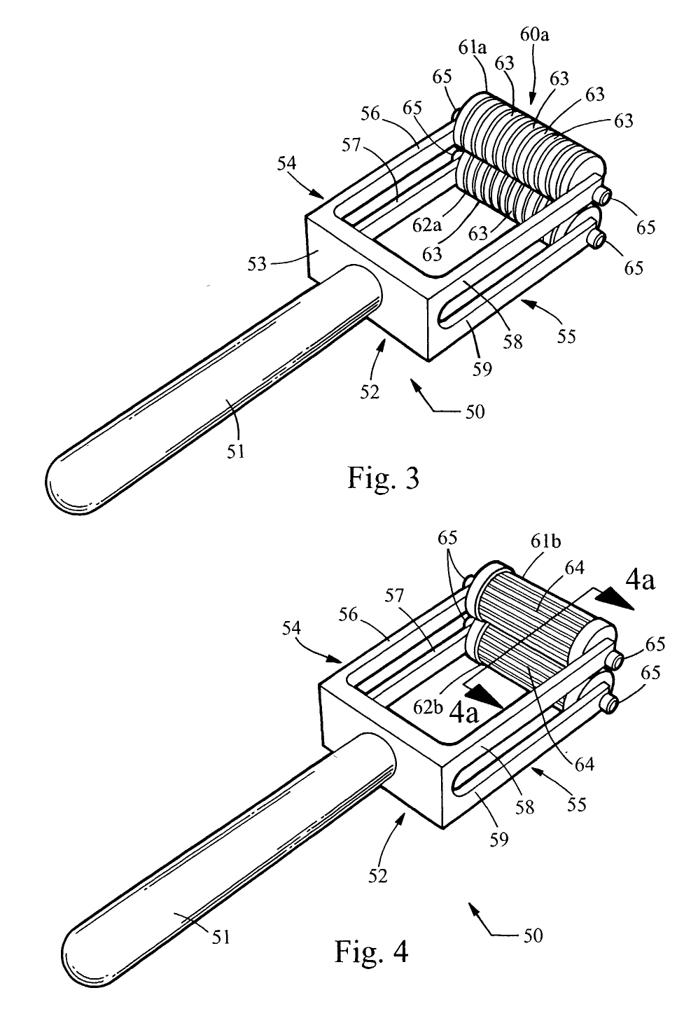

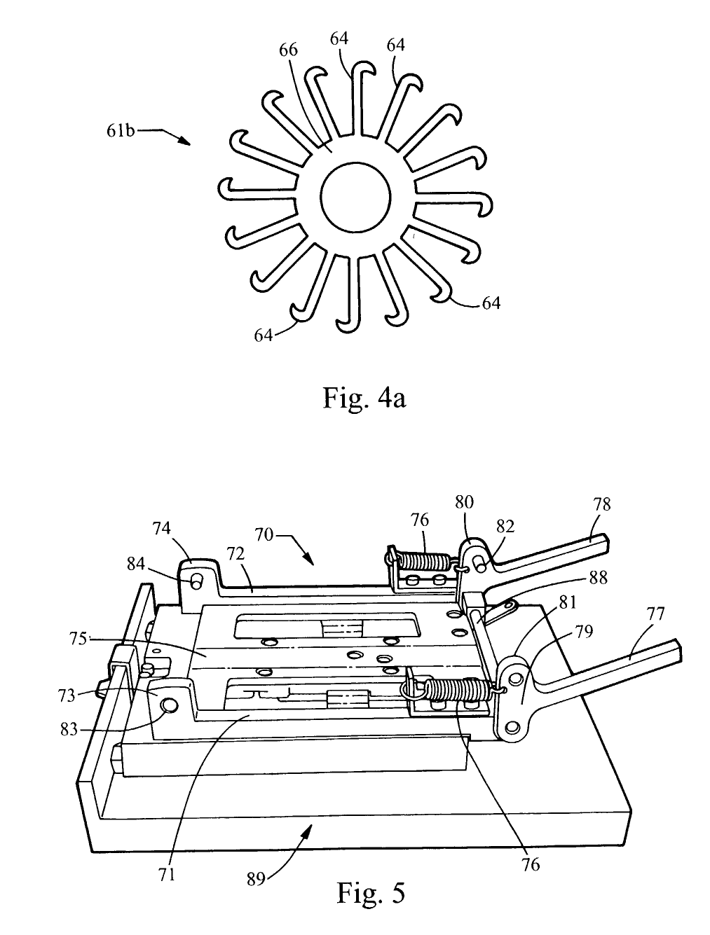

As will be described in more detail herein, the pair of rollers 60 are utilized to press the conformal tape 90, which is held by the tape holder 30, onto the flatwire to be repaired. Accordingly, it will be recognized that numerous different types of rollers 60 can be utilized with the present invention. The rollers 61, 62 depicted in FIG. 2 generally have a smooth outer surface for a smooth consistent application of the conformal tape 90. Alternate embodiments of the rollers 60 are shown in FIGS. 3 and 4. In these figures, all common elements have been denoted with common reference numerals.

In FIG. 3, a different set of rollers 60a has been illustrated. Again, the roller 60a include an upper roller 61a and a lower roller 62a. The rollers 61a, 62a are comprised of a plurality of individual discs 63 which are axially aligned. Preferably, the discs 63 are axially spaced apart, which can be accomplished by incorporating spacers, such as washers, (not shown) between the discs 63. During use of the roller 50, the axial spacing of the discs 63 allows air trapped beneath the conformal tape 90 to be forced out during the sealing process.

The tape roller 50 depicted in FIG. 4 includes yet another alternate set of rollers 60b including an upper roller 61b and a lower roller 62b. The configuration of the rollers 61b, 62b is identical, and is best seen in the cross sectional view of FIG. 4a, which is taken along the line 4a-4a in FIG. 4. As can be seen, the rollers 60b each include a hub 66 having a plurality of arms 64 extending radially therefrom. The arms 64 extend longitudinally along each roller 61b, 62b. The arms 64 are constructed of a deflectable material such that the arms 64 bend when a force is applied, i.e., during the rolling process performed on the conformal tape 90, as will be described later herein. The distal end of each arm 64 is preferably curved to provide smooth surface for engaging the tape 90. Similar to the embodiment depicted in FIG. 3, this configuration of rollers 60b utilizing-a plurality of radially extending arms 64 permits air to be forced out during the sealing process. These and many other configurations of the rollers 60 will be readily apparent to those skilled in the art.

Turning now to FIG. 5, a base fixture 70 is depicted that can form a portion of the sealing tool 20 in accordance with the present invention. The base fixture 70 is an optional part of the tool 20, and may be utilized to provide alignment to a lower structure where the flatwire is attached. The essential components of the base fixture include a left wall 71 defining a flange 73 at its rear end, and a right wall 72 defining a flange 74 at its rear end. A base plate 75 extends between the left and right walls 71, 72. A pair of release arms 77, 78 are pivotally attached to the left to right walls 71, 72, respectively. The left and right release arms 77, 78 are rigidly connected by a connector 88. One end of the release arms 77, 78 include pivot bars 79, 80 which provide the pivotal attachment to the left right wall 71, 72. The pivot bar 79, 80 are biased by springs 76 into a locked position. Pressing downwardly on either one of the release arms 77, 78 cams the pivot bars 79, 80, and more particularly locking pegs 81, 82 forwardly to an open position. The left and right walls 71, 72, and more particularly the flanges 73, 74 define rear locking pegs 83, 84 corresponding to pegs 81, 82.

Returning to FIG. 1, it can be seen that the tape holder 30 includes a pair of feet 85 each having front and rear slots 86, 87. Each of the slots 86, 87 correspond with the locking pegs 81, 82, 83, 84 of the base fixture 70. Thus, the release arms 77, 78 allow the pegs 81, 82 to be selectively positioned to either lock the tape holder 30 in place, or permit entry and removal of the same. Finally, the base fixture 70 may clip on or otherwise attach to a flatwire support structure such as the plates 89 shown in FIG. 5, which allows special positioning relative to the electronics to be repaired.

The sealing tool 20 as described above is designed for use with at least one and preferably two tapes 90 which include a conformal coating for application to the flatwire or related electronics. As shown in FIGS. 6 and 7, each tape 90 is comprises of a plurality of layers including a backer layer 91, a high/low adhesive layer 92, a protective polymer or conformal coating layer 93, a protective adhesive or sealant layer 94, and a liner layer 95. The polymer layer 93 can also be metallized. Alternately, a metal foil can be bonded to the tape as an additional layer proximate the conformal layer 93. In both cases, the metallized conformal coating or the additional metal foil layer provides additional environmental protection along with electromagnetic interference protection (EMI) with proper grounding.

It can be seen that the backer 91 is larger than the other layers 92, 93, 94, 95. More particularly, the backer 91 is wider than the other layers to define two opposing gripping portions 96 that extend beyond the other layers. As will be described herein, the gripping portions 96 are utilized to position the tape 90 within the tape holder 30. Additionally, the removable liner 95 is slightly longer than the other layers 91, 92, 93, 94 to define a gripping portion 97 providing easy removal of the liner 95.

Turning now to FIGS. 8-11, the process of applying the protective conformal layer 93 to a flatwire or related electronics will be described. As shown in FIG. 8, two opposing tapes 90 are positioned within the tape holder 30 for application to upper and lower surfaces of a flatwire. The first step includes removing the liners 95 from each of the tapes 90 by grasping the gripping portion 97 and removing the liner 95. This leaves the polymer or conformal layer 93 and the adhesive layer 94 exposed. It will be seen that the adhesive layer 92 connecting the backer 91 to the conformal layer 93 will be of sufficient strength to keep the layers 91, 93 adhere to one another when the liner 95 is removed.

Stated another way, the peel strength of the backer layer 91 to the adhesive layer 92 is greater than the peel strength of the liner layer 95 to the adhesive layer 94. This is generally accomplished by constructing the liner of polyethylene or polypropylene for a low peel strength. With the liner 95 removed, a first tape 90 is positioned in the upper slot 41 defined in the tape holder 30. As previously described, the upper slot 41 is formed in the upper jaw 32 as defined by opposing channels 43 and 45. As briefly discussed earlier, the first tape 90 in the upper slot 41 has its exposed adhesive layer 94 facing downwardly. Similarly, a second tape 90 is positioned within the lower slot 42, as defined by the channels 46 and 48. The slots 41, 42 provide predetermined positioning of the two tapes 90. More specifically, the slots 41, 42 allows the tapes 90 adhesive layer 94 to be exposed and positioned a given distance relative to the flatwire to be sealed, preferably 0.010 inches to 0.100 inches. Further, these slots 41, 42 are designed to flatten the tape so that the tape roller 50 will apply the tape without bubbles to the flatwire.

Turning now to FIG. 9, the tape holder 30, having the tapes 90 positioned therein, is connected to the base fixture 70 by camming the release arms 77, 78 back, to allow the feet 85 of the tape holder 30 to be positioned on the base fixture 70, and the slots 86, 87 to receive the tabs 81, 82, 83 and 84.

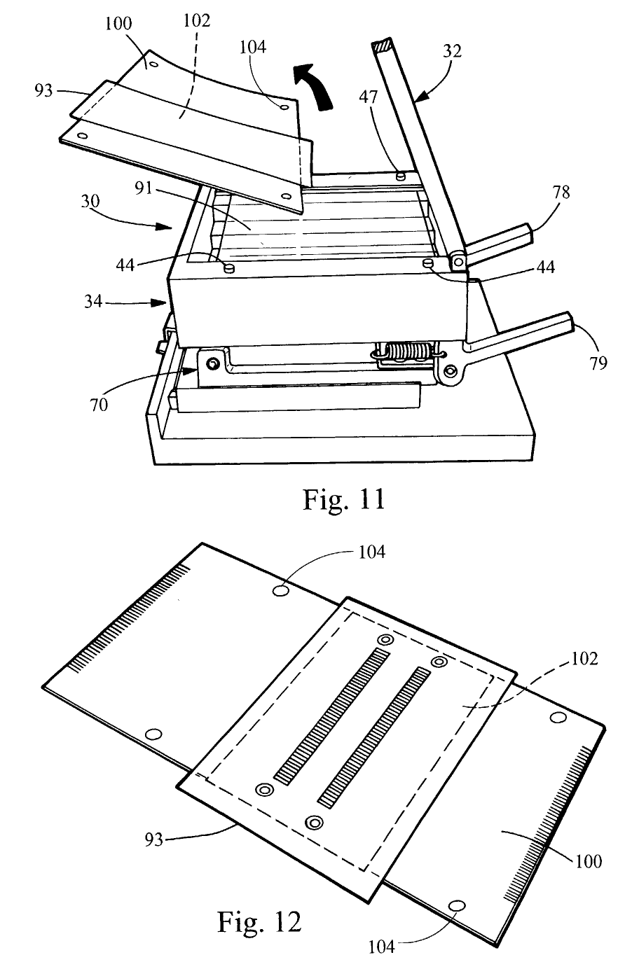

Then, the upper jaw 32 is rotated upwardly about hinge 33 so that the flatwire 100 may be placed therebetween. As shown in FIG. 9, the flatwire 100 has been depicted as being updated with a flatwire bus 102 connected thereto, the bus 102 being exposed for sealing. As is known in the art, flatwire typically includes regularly spaced holes 104 along its outer edges. Accordingly, the present invention provides tabs 44, 47 on the upper surface of the lower jaw 34 (see FIG. 11) which correspond and fit into the predetermined holes 104 for reliable positioning of the flatwire 100 relative to the tape 90 for easy application of the conformal coating.

Once the flatwire 100 is in place within the tape holder 30, the upper jaw 32 is again lowered to sandwich the flatwire 100 between the upper and lower jaws 32, 34, as shown in FIG. 10. The tape roller 50 is then utilized to attach the conformal film layer 93 to the flatwire 100. More specifically, the tape roller 50 is inserted into the open front end of the tape holder 30, and the positioning prongs 65 are located within the guide slot 31, as well as being guided by the upper surface 35′, 37′ of the left and right bars 35, 37. The tape roller 50 is moved completely within the tape holder 30, and then is retracted. The rollers 60 are positioned to provide a downward force on the first tape 90 in the upper jaw 32, as well as an upward force on the second tape 90 held in the lower jaw 34. Accordingly, the tapes 90, and more specifically the conformal film layers 93 are attached to the flatwire 100 by way of the adhesive layers 94. It will be recognized that the tape sealing tool 20 of the present invention provides simultaneous sealing of a conformal film to the flatwire 100 on both its upper and lower surfaces, without any air pockets in the coating.

Turning now to FIG. 11, once the conformal coating layer 93 has been applied, the upper jaw 32 is rotated to open up the tape holding tool 30, and the flatwire 100 is removed. Subsequently, the tape holder 30 may be removed from the base fixture 70 by operating the release arms 77 or 78. It can also be seen that the backer 91 is left within the tape holder 30, and more specifically two backers 91 are left in the upper and lower jaws 32, 34, respectively. That is, the backers 91 are detached from the polymer or conformal layer 93 when first, the upper jaw 32 is rotated, and then second, when the flatwire 100 is lifted from the lower jaw 34. Plus, the adhesion of the conformal layer 93 to the flatwire 100 by way of adhesive layer 94 is stronger (in peel strength) than the bond between the conformal layer 93 and the backer 91 by way of adhesive layer 92.

As best seen in FIG. 12, the final configuration of the upgraded flatwire 100 includes a conformal film layer 93 over the upgraded site. More particularly, the size of the conformal layer 93 is such that it extends slightly beyond the flatwire 100 so that the edges of the wire 100 are completely sealed against the elements. Furthermore, the conformal layer 93 is of an appropriate width to fully seal against the wholly intact upper surface of the flatwire 100 and protect the bus 102. Accordingly, the flatwire bus 102 of the present illustration is completely sealed from mechanical and environmental stresses (i.e. moisture ingress, abrasion resistance) from all sides. Furthermore, the operation can be performed quickly and on-site, while smoothly applying a conformal layer 93 that eliminates any air bubbles or non-uniform application.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A sealing tool for sealing upper and lower surfaces of a flatwire by applying conformal films to the upper and lower surfaces, the conformal films being carried by first and second tapes, the sealing tool comprising:
a tape holder having an upper jaw and a lower jaw, the upper jaw defining an upper slot for receiving the first tape having the conformal film, the lower jaw defining a lower slot for receiving the second tape having the conformal film; and
a tape roller sized to fit within the tape holder, the tape roller having an upper roller and a lower roller, the upper roller positioned relative to the upper slot to apply the conformal film of the first tape to the upper surface of the flatwire, the lower roller positioned relative to the lower slot to apply the conformal film of the second tape to the lower surface of the flatwire.

2. The sealing tool of claim 1, wherein the upper jaw is movable relative to the lower jaw for positioning said flatwire between the upper and lower jaws.

3. The sealing tool of claim 2, wherein the upper and lower jaw are hingedly connected to rotate relative to one another.

4. The sealing tool of claim 1, wherein the tape holder has a guide slot for receiving and guiding the tape roller.

5. The sealing tool of claim 4, wherein the lower jaw defines the guide slot.

6. The sealing tool of claim 4, wherein the tape roller includes a peg sized to be received within the guide slot.

7. The sealing tool of claim 4, wherein the lower jaw defines a guide slot having opposing channels, and wherein the tape roller includes opposing pegs sized and positioned to be received within the opposing channels.

8. The sealing tool of claim 1, wherein the tape holder includes a stop wall to limit movement of the tape roller relative to the tape holder.

9. The sealing tool of claim 1, wherein the upper and lower jaws each include a left wall, a right wall, and a stop wall connecting the left and right walls.

10. The sealing tool of claim 9, wherein the upper and lower slots are defined in the left and right walls of the upper and lower jaws.

11. The sealing tool of claim 1, further comprising a base sized to receive the lower jaw of the tape holder for positioning relative to the flatwire.

12. The sealing tool of claim 1, wherein the upper roller and lower roller each have a smooth outer surface.

13. The sealing tool of claim. 1, wherein the upper roller and lower roller each comprise a plurality of rolling discs, the plurality of rolling discs being axially aligned.

14. The sealing tool of claim 1, wherein the upper roller and lower roller each comprise a nub wheel having a plurality of radially extending arms, the arms being deflectable.

15. A sealing tool for sealing upper and lower surfaces of a flatwire by applying conformal films to the first and second surfaces, the sealing tool comprising:
a first tape and a second tape, the first and second tapes each carrying a conformal film for application to the flatwire;
a tape holder having a first jaw and a second jaw, the first jaw defining a first slot sized to receive the first tape, the second jaw defining a second slot sized to receive the second tape; and
a tape roller sized to fit within the tape holder, the tape roller having a first roller and a second roller, the first roller positioned relative to the first slot to exert a force on the first tape when positioned in the first slot to apply the conformal film to the first surface of the flatwire, the second roller positioned relative to the second slot to exert a force on the second tape when positioned in the second slot to apply the conformal film to the second surface of the flatwire.

16. The sealing tool of claim 15, wherein the first tape and second tape each comprise a plurality of layers including a backer layer attached to a conformal film layer, the first and second slots in the first and second jaws being sized to receive the backer layer of the first and second tapes.

17. The sealing tool of claim 16, wherein the backer layer is larger than the conformal film layer to define a gripping portion of the backer layer extending beyond the conformal film layer, the gripping portion corresponding with the first and second slots.

18. The sealing tool of claim 17, wherein the backer layer is retained by the tape holder upon application of the conformal film to the flatwire.

19. The sealing tool of claim 16, wherein the plurality of layers further includes a first adhesive layer connecting the backer layer to the conformal film layer, and wherein the plurality of layers further includes liner layer attached to the conformal film layer by a second adhesive layer.

20. The sealing tool of claim 19, wherein the peel strength of the liner layer to the second adhesive layer is lower than the peel strength of the backer layer to the first adhesive layer.
